(19) United States
(12) Patent Application Publication
(10) Pub. No.: US 2018/0215987 A1
(43) Pub. Date: Aug. 2, 2018

(54) USE OF CARBONATES AS WELLBORE TREATMENT

(71) Applicant: HALLIBURTON ENERGY SERVICES, INC., Houston, TX (US)

(72) Inventors: Cato Russell McDaniel, The Woodlands, TX (US); Bill Shumway, Houston, TX (US)

(73) Assignee: HALLIBURTON ENERGY SERVICES, INC., Houston, TX (US)

(21) Appl. No.: 15/506,212

(22) PCT Filed: Sep. 29, 2014
(86) PCT No.: PCT/US2014/058026

§ 371 Date: Feb. 23, 2017

(51) Int. Cl. C09K 8/12; C09K 8/035

(52) U.S. Cl. CPC C09K 8/12; C09K 8/035

(57) ABSTRACT

A method of drilling a subterranean formation includes drilling the subterranean formation with a drilling fluid including a carbonate base fluid and an aqueous base fluid. The carbonates may be selected from ethylene carbonate, propylene carbonate, glycerol carbonate, butylene carbonate, 1,3-propylene carbonate, dialkylcarbonates, dimethylcarbonate, and mixtures thereof. Drilling fluids may include a carbonate base fluid, an aqueous base fluid and an optional base oil.

### BACKGROUND

A drilling fluid or mud is a specially designed fluid that is circulated through a wellbore as the wellbore is being drilled to facilitate the drilling operation. The various functions of a drilling fluid include removing drill cuttings from the wellbore, cooling and lubricating the drill bit, aiding in support of the drill pipe and drill bit, and providing a hydrostatic head to maintain the integrity of the wellbore walls and prevent well blowouts. Specific drilling fluid systems are selected to optimize a drilling operation in accordance with the characteristics of a particular geological formation.

Oil or synthetic fluid-based muds are normally used to drill swelling or sloughing shales, salt, gypsum, anhydrite or other evaporate formations, hydrogen sulfide-containing formations, and hot (greater than about 300° F.) holes, but may be used in other holes penetrating a subterranean formation as well. Unless indicated otherwise, the terms “oil mud” or “oil-based mud or drilling fluid” shall be understood to include synthetic oils or other synthetic fluids as well as natural or traditional oils, and such oils shall be understood to comprise invert emulsions.

Oil-based muds used in drilling typically comprise: a base oil (or synthetic fluid) comprising the external phase of an invert emulsion; a hygroscopic, aqueous solution (typically a solution comprising about 30% calcium chloride) comprising the internal phase of the invert emulsion; emulsifiers at the interface of the internal and external phases; and other agents or additives for suspension, weight or density, oil-wetting, fluid loss or filtration control, and rheology control. Such additives commonly include organophilic clays and organophilic lignites. An oil-based or invert emulsion-based drilling fluid may commonly comprise between about 50:50 to about 95:5 by volume oil or oleaginous phase to water or aqueous phase.

“Clay-free” invert emulsion-based drilling fluids offer different properties over drilling fluids containing organophilic clays. As used herein, the term “clay-free” (or “clayless”) means a drilling fluid made without addition of any organophilic clays or lignites to the drilling fluid composition.

In conventional invert emulsion drilling fluids, and in some “clay-free” invert-emulsion drilling fluids, brine rather than pure water is used for the internal phase because the salts such as calcium chloride in the brine enable balancing of osmotic pressures during drilling through shales. That is, the salt helps keep the water activity of the drilling fluid the same as the water activity of the shale, thereby preventing the flow of water from the drilling fluid into the shales and thus avoiding swelling of the shales. The concentration of salt used in the internal phase depends on the activity of water present in the shales.

Use of high concentrations of chloride salts can give rise to disposal issues and environmental concerns and can also result in high conductivity which interferes with the sensitivity of induction logs during exploratory drilling. Alternative electrolytes, such as potassium acetate or formate, have been used, but these salts are often cost prohibitive and still limit induction log sensitivity. Other substitutes such as potassium chloride, sodium chloride and magnesium sulfate result in similar disposal issues.

Alcohols, particularly glycerols, polyglycerols, and cyclic ether polyols have also been tried as an alternative to calcium chloride brines for the internal phase of conventional invert emulsion drilling fluids. An advantage of using alcohols in the internal phase is that much of the concern for the ionic character of the internal phase is no longer required. When water is not present in the system, hydration of the shales is greatly reduced. Alcohols can still interact with the clays of the shales but swelling is considered still significantly less than with water. Conventionally, the problem with using alcohols as an internal phase of an invert emulsion is that the invert emulsions tend to be less stable at the high temperatures commonly encountered in subterranean formations during drilling for hydrocarbons. This instability is believed to be due to the alcohols tending to separate or become insoluble at elevated temperatures. Even when more heat tolerant alcohols are employed, barite settling and an undesirably high filtrate rate indicating invert emulsion instability at high temperatures and high pressures have been observed.

Clay-free invert emulsion fluids formulated without the organophilic clay provide gels which are high but yet break easily on application of lower pump pressures than similar organophilic clay containing fluids. Clay-free invert emulsion drilling fluids have been shown to yield high performance drilling, with “fragile gel” strengths and rheology leading to lower equivalent circulating density (ECDs) and improved rate of penetration (ROP). ECD is the effective density exerted by a circulating fluid against the formation, and accounts for the pressure drop in the annulus above the point being considered. Due to easy conversion from a gel to liquid phase, the equivalent circulating density spikes usually observed are lower or absent when breaking circulation, tripping in & out and during connections. The lower or absent ECD spikes reduces the probability of induced fractures which translates into lower fluid losses into the formation, where fluid is lost (e.g., leaking off) into other portions or fractures in the formation besides the dominant fracture. High gel strength observed in clay free invert emulsion fluids provides enough suspension to prevent any barite from settling reducing incidents of a density gradient and worst case scenario which is SAG, the settling of particles in the annulus of a well, which can lead to a well control situation. The high gels also aids in hole cleaning by suspending the drill solids and preventing them from falling back to the bottom and interfering with the function of the bit. One more advantage realized without the addition of the organophilic clay is the absence of thick progressive gels that are observed after long static periods. A thick gel can require enormous pump pressures before the gel transition to a liquid and flow. A high pump pressure implies a high ECD which is experienced at the bottom leading to induced fractures and therefore losses.

An essential criterion for assessing the utility of a fluid as a drilling fluid or as a well service fluid may include the fluid's rheological parameters, particularly under simulated drilling and well bore conditions. For use as a drilling fluid, or as a fluid for servicing a well, a fluid generally should be capable of maintaining certain viscosities suitable for drilling and circulation in the well bore. Preferably, a drilling fluid will be sufficiently viscous to be capable of supporting and carrying the well drill cuttings to the surface without being so viscous as to interfere with the drilling operation. Moreover, a drilling fluid must be sufficiently viscous to be able to suspend barite and other weighting agents. However, increased viscosity can result in problematic sticking of the drill string, and increased circulating pressures can contribute to lost circulation problems.

Thus, a need exists for a drilling fluid with improved rheological and stability characteristics, biodegradability, and reduced quantities of weighting materials.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIG. 1 shows an illustrative example of an apparatus useful for drilling a wellbore with the drilling fluid compositions of the invention.

### DETAILED DESCRIPTION

The present invention generally relates to a carbonate containing drilling fluid with improved performance in the field, and a method of drilling employing that drilling fluid. An optional oil base may be a natural oil such as for example diesel oil, a synthetic base, or mineral oil.

In one embodiment of the invention, a method of drilling a subterranean formation includes providing or using a drilling fluid comprising: a carbonate base fluid; and an aqueous base fluid. The carbonate base fluid may comprise at least one of ethylene carbonate, propylene carbonate, glycerol carbonate, butylene carbonate, 1,3-propylene carbonate, dialkylcarbonates, dimethylcarbonate, and mixtures thereof. In some embodiments, the carbonate base fluid may comprise at least one of ethylene carbonate, glycerol carbonate, and mixtures thereof. The aqueous base fluid may comprise at least one of fresh water, acidified water, salt water, seawater, brine, an aqueous salt solution, and mixtures thereof. In exemplary embodiments, the drilling fluid may further comprise at least one base oil selected from the group of oils consisting of synthetic oils comprising an ester or olefin; diesel oils; mineral oils selected from the group consisting of n-paraffins, isoparaffins, cyclic alkanes, branched alkanes, and mixtures thereof. In an embodiment, the carbonate base fluid comprises glycerol carbonate and the base oil comprises diesel oil. The aqueous base fluid may include at least one of fresh water, acidified water, salt water, seawater, brine, an aqueous salt solution, and mixtures thereof. In several embodiments, the carbonate base fluid includes glycerol carbonate and the base oil includes diesel oil. The volume percentage of oil base fluid with respect to the volume percentage of aqueous base fluid may range from about 50% to about 100%. In some embodiments, the volume percentage of oil base fluid with respect to the volume percentage of aqueous base fluid may range from about 50% to about 99%. The carbonate base fluid may be present in the drilling fluid in the amount of about 1% to about 90% by volume. The drilling fluid may include at least one additive from the group consisting of weighting agents, inert solids, fluid loss control agents, emulsifiers, salts, dispersion aids, corrosion inhibitors, emulsion thinners, emulsion thickeners, viscosifiers, HPHT emulsifier filtration control agents, and any combination thereof. The drilling fluid may also be solids free.

In an embodiment of the invention, a drilling fluid comprises: a carbonate base fluid; and an aqueous base fluid. The carbonate base fluid may comprise at least one of ethylene carbonate, propylene carbonate, glycerol carbonate, butylene carbonate, 1,3-propylene carbonate, dialkylcarbonates, dimethylcarbonate, and mixtures thereof. In some embodiments, the carbonate base fluid may comprise at least one of ethylene carbonate, glycerol carbonate, and mixtures thereof. The aqueous base fluid may comprise at least one of fresh water, acidified water, salt water, seawater, brine, an aqueous salt solution, a glycol, an alcohol, and mixtures thereof. In exemplary embodiments, the drilling fluid may further comprise at least one base oil selected from the group of oils consisting of synthetic oils comprising an ester or olefin; diesel oils; mineral oils selected from the group consisting of n-paraffins, isoparaffins, cyclic alkanes, branched alkanes, and mixtures thereof. In an embodiment, the carbonate base fluid comprises glycerol carbonate and the base oil comprises diesel oil. The aqueous base fluid may include at least one of fresh water, acidified water, salt water, seawater, brine, an aqueous salt solution, and mixtures thereof. In several embodiments, the carbonate base fluid includes glycerol carbonate and the base oil includes diesel oil. The volume percentage of oil base fluid with respect to the volume percentage of aqueous base fluid may range from about 50% to about 100%. The carbonate base fluid may be present in the drilling fluid in the amount of about 50 to about 90. The drilling fluid may include at least one additive from the group consisting of weighting agents, inert solids, fluid loss control agents, emulsifiers, salts, dispersion aids, corrosion inhibitors, emulsion thinners, emulsion thickeners, viscosifiers, HPHT emulsifier filtration control agents, and any combination thereof. The drilling fluid may also be solids free.

In another embodiment of the invention, a drilling fluid comprises glycerol carbonate. The drilling fluid may further include at least one base oil selected from the group of oils consisting of synthetic oils comprising an ester or olefin; diesel oils; mineral oils selected from the group consisting of n-paraffins, isoparaffins, cyclic alkanes, branched alkanes, polyethylene glycols, and mixtures thereof. In some embodiments, no aqueous base fluids are present in the drilling fluid.

In one embodiment of the invention, a method of drilling a subterranean formation includes providing or using a drilling fluid comprisingglycerol carbonate. The method may further include adding at least one base oil selected from the group of oils consisting of synthetic oils comprising an ester or olefin; diesel oils; mineral oils selected from the group consisting of n-paraffins, isoparaffins, cyclic alkanes, branched alkanes, polyethylene glycols, and mixtures thereof. In some embodiments, no aqueous base fluids are added to the drilling fluid.

Another embodiment of the invention includes a subterranean formation drilling system including: a drilling apparatus configured to drill with a drilling fluid, said drilling fluid comprising: a carbonate base fluid; and an aqueous base fluid and optionally, at least one base oil selected from the group of oils consisting of synthetic oils comprising an ester or olefin; diesel oils; mineral oils selected from the group consisting of n-paraffins, isoparaffins, cyclic alkanes, branched alkanes, and mixtures thereof.

As used herein, the term “drilling” or “drilling wellbores” shall be understood in the broader sense of drilling operations, which includes running casing, completion operations, and cementing as well as drilling, unless specifically indicated otherwise. The method of the invention comprises using the drilling fluid of the invention in drilling wellbores.

As used herein, a “fluid” is a substance having a continuous phase that can flow and conform to the outline of its container when the substance is tested at a temperature of 71° F. (22° C.) and a pressure of one atmosphere “atm” (0.1 megapascals “MPa”). A fluid can be a liquid or gas. A homogenous fluid has only one phase; whereas a heterogeneous fluid has more than one distinct phase. A colloid is an example of a heterogeneous fluid. A colloid can be: a slurry, which includes a continuous liquid phase and undissolved solid particles as the dispersed phase; an emulsion, which includes a continuous liquid phase and at least one dispersed phase of immiscible liquid droplets; or a foam, which includes a continuous liquid phase and a gas as the dispersed phase. As used herein, the term “emulsion” means a colloid in which an aqueous liquid is the continuous (or external) phase and a hydrocarbon liquid is the dispersed (or internal) phase. As used herein, the term “invert emulsion” means a colloid in which a hydrocarbon liquid is the external phase and an aqueous liquid is the internal phase. There can be more than one internal phase of the emulsion or invert emulsion, but only one external phase. For example, there can be an external phase which is adjacent to a first internal phase, and the first internal phase can be adjacent to a second internal phase. Any of the phases of an emulsion or invert emulsion can contain dissolved materials and/or undissolved solids.

The term “solids-free” as applied to the basic well service fluid shall be understood to mean that no solid materials (e.g., weighting agents or commercial particulates) are present in the wellbore fluid (except that the term is not intended to exclude the presence of drill cuttings in the fluid in the well).

In embodiments where the drilling fluid is free of organophilic clay, the drilling fluid of the invention provides the advantages of an organophilic clay-free system as well as high pressure and high temperature stability. While some organophilic clay may enter the fluid in the field, for example due to mixing of recycled fluids with the fluid of the invention, the fluid of the invention is tolerant of such clay in insubstantial quantities, that is in quantities less than about 3 pounds per barrel.

Base Oils

In some embodiments of the invention, the base oil of the drilling fluid may include at least one of synthetic oils comprising an ester or olefin; diesel oils; mineral oils selected from the group consisting of n-paraffins, isoparaffins, cyclic alkanes, branched alkanes, and mixtures thereof. Synthetic oils may include, for example, ACCOLADE® Drilling Fluid System base fluid comprising esters or ENCORE® Drilling Fluid System base fluid comprising isomerized olefins, both available from Halliburton Energy Services, Inc., in Houston, Tex.

In some embodiments, the base oil is present in the treatment fluid the amount of from about 50% to about 99% by volume of the treatment fluid. The volume percentage of oil base fluid with respect to the volume percentage of aqueous base fluid may range from about 50% to about 100%.

Aqueous Base Fluid

In several embodiments, an aqueous base fluid may be used. The aqueous base fluid of the present embodiments can generally be from any source, provided that the fluids do not contain components that might adversely affect the stability and/or performance of the treatment fluids of the present invention. In various embodiments, the aqueous carrier fluid can comprise fresh water, acidified water, salt water, seawater, brine, or an aqueous salt solution. In some embodiments, the aqueous carrier fluid can comprise a monovalent brine or a divalent brine. Suitable monovalent brines can include, for example, sodium chloride brines, sodium bromide brines, potassium chloride brines, potassium bromide brines, and the like. Suitable divalent brines can include, for example, magnesium chloride brines, calcium chloride brines, calcium bromide brines, and the like. The aqueous base fluid may also contain alcohols and glycols.

In some embodiments, the aqueous base fluid is present in the treatment fluid the amount of from about 30% to about 98% by volume of the treatment fluid.

Carbonate Base Fluid

In embodiments of the invention, carbonates may replace water or oil in a drilling mud formulation. These carbonates may include ethylene carbonate (EC), propylene carbonate (PC), glycerol carbonate (GC), and butylene carbonate (BC), 1,3-propylene carbonate, and dialkylcarbonates such as dimethylcarbonate. The term glycerol carbonate is used interchangeably with glycerine carbonate. The density of the EC, PC and GC makes the mud heavier. Some inorganics are soluble in EC, PC and GC allowing “brines” to be made to further increase the density. EC has a density of 1.32 g/mL (11 lbs./gal), PC also has a density of 1.3 g/mL. GC has a density of 1.4 g/mL (11.7 lbs/gal). These high densities may be useful to preventing SAG etc. These materials may be useful in preparing solids free or salt free drill in fluids. Water is soluble in these carbonates, although more so in ethylene carbonate and glycerol carbonate. These materials may be used as shale stabilizers.

EC has a boiling point of 260° C. (501° F.) and a flash point of 150° C. (302° F.) and is biodegradable. PC has a boiling point of 242° C. (468° F.) and a flash point of 132° C. (270° F.). The freezing point of EC is 34° C. (93° F.) and the freezing point of PC is −48.8° C. (−55.8° F.). The freezing point of glycerol carbonate is −69° C. (−92.2° F.) so very cold tolerant fluids can be made with PC and GC. The high freezing point of EC can be mitigated by adding PC and other materials.

The term “carbonate base fluid” means a fluid containing at least one of ethylene carbonate, propylene carbonate, glycerol carbonate, butylene carbonate and mixtures thereof. The carbonates in the “carbonate base fluids” of the invention are liquids. In contrast, iron and zinc carbonate are other solid carbonates that have been used in the oilfield. In some embodiments of the invention, the carbonate base fluid comprises at least one of ethylene carbonate, propylene carbonate, glycerol carbonate, butylene carbonate, 1,3-propylene carbonate, dialkylcarbonates, dimethylcarbonate, and mixtures thereof. In certain embodiments, the carbonate base fluid comprises at least one of ethylene carbonate, glycerol carbonate, and mixtures thereof. In a preferred embodiment, the carbonate base fluid comprises glycerol carbonate.

In an embodiment, the carbonate base fluid is present in the amount of about 1% to about 90% by volume.

Fluid Density

In certain embodiments, the drilling fluids have a density which is pumpable for introduction down hole. In exemplary embodiments, the density of the drilling fluids is from about 8.5 pounds per gallon (ppg) to about 20 ppg.

Fluid Additives

Typical additives suitable for use in drilling fluids of the present invention include at least one additive from the group consisting of weighting agents, inert solids, fluid loss control agents, emulsifiers, salts, dispersion aids, corrosion inhibitors, emulsion thinners, emulsion thickeners, viscosifiers, HPHT emulsifier filtration control agents, and any combination thereof. Non-limiting examples include: additives to reduce or control temperature rheology or to provide thinning, for example, additives having the tradenames COLDTROL™, ATC™, and OMC2™; additives for enhancing viscosity, for example, an additive having the tradename RHEMOD L™; additives for providing temporary increased viscosity for shipping (transport to the well site) and for use in sweeps, for example, an additive having the tradename TEMPERUS™ (modified fatty acid); additives for filtration control, for example, additives having the tradename ADAPTA™; emulsifier activator like lime, additives for high temperature high pressure control (HTHP) and emulsion stability, for example, additives having the tradename FACTANT™ (highly concentrated tall oil derivative), which is present in the paraffin/mineral oil-based drilling system having the tradename INNOVERT™; and additives for emulsification, for example, additives having the tradename EZ MUL NT™ (polyaminated fatty acid). All of the aforementioned trademarked products are available from Halliburton Energy Services, Inc. in Houston, Tex. One of skill in the art will realize that the exact formulations of the fluids of the invention vary with the particular requirements of the subterranean formation.

Drilling fluids of the present invention comprising the carbonates have many advantages including the following: These materials are relatively low cost to conventional fluid components and much denser than oil or water (1.4 vs. 0.8 or 1.0). Also, solids free fluids can be made with these materials. Further these materials are “green,” i.e., they are biodegradable and fairly non-toxic. The materials possess high boiling points and flash points.

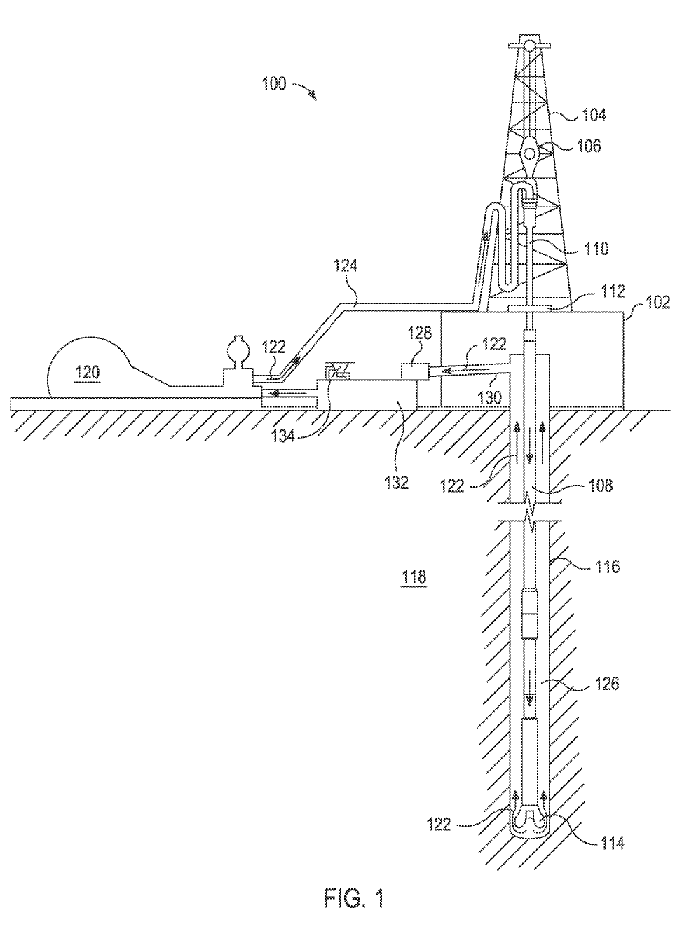

The exemplary drilling fluids disclosed herein may directly or indirectly affect one or more components or pieces of equipment associated with the preparation, delivery, recapture, recycling, reuse, and/or disposal of the disclosed drilling fluid compositions. For example, and with reference to FIG. 1, the disclosed drilling fluid compositions may directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates the drilling fluids of the present invention 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed components may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed components may be added to the drilling fluid 122 at any other location in the drilling assembly 100. In at least one embodiment, for example, there could be more than one retention pit 132, such as multiple retention pits 132 in series. Moreover, the retention put 132 may be representative of one or more fluid storage facilities and/or units where the disclosed components may be stored, reconditioned, and/or regulated until added to the drilling fluid 122.

As mentioned above, the disclosed drilling compositions may directly or indirectly affect the components and equipment of the drilling assembly 100. For example, the disclosed drilling compositions may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, any fluid reclamation equipment. The fluid processing unit(s) 128 may further include one or more sensors, gauges, pumps, compressors, and the like used store, monitor, regulate, and/or recondition the exemplary drilling fluid compositions.

The disclosed drilling compositions may directly or indirectly affect the pump 120, which representatively includes any conduits, pipelines, trucks, tubulars, and/or pipes used to fluidically convey the drilling fluid compositions downhole, any pumps, compressors, or motors (e.g., topside or downhole) used to drive the drilling fluid compositions into motion, any valves or related joints used to regulate the pressure or flow rate of the drilling fluid compositions, and any sensors (i.e., pressure, temperature, flow rate, etc.), gauges, and/or combinations thereof, and the like. The disclosed drilling fluid compositions may also directly or indirectly affect the mixing hopper 134 and the retention pit 132 and their assorted variations.

The disclosed drilling compositions may also directly or indirectly affect the various downhole equipment and tools that may come into contact with the drilling compositions such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed drilling compositions may also directly or indirectly affect any downhole heat exchangers, valves and corresponding actuation devices, tool seals, packers and other wellbore isolation devices or components, and the like associated with the wellbore 116. The disclosed drilling compositions may also directly or indirectly affect the drill bit 114, which may include, but is not limited to, roller cone bits, PDC bits, natural diamond bits, any hole openers, reamers, coring bits, etc.

While not specifically illustrated herein, the disclosed drilling compositions may also directly or indirectly affect any transport or delivery equipment used to convey the drilling compositions to the drilling assembly 100 such as, for example, any transport vessels, conduits, pipelines, trucks, tubulars, and/or pipes used to fluidically move the drilling compositions from one location to another, any pumps, compressors, or motors used to drive the drilling compositions into motion, any valves or related joints used to regulate the pressure or flow rate of the drilling compositions, and any sensors (i.e., pressure and temperature), gauges, and/or combinations thereof, and the like.

The invention having been generally described, the following examples are given as particular embodiments of the invention and to demonstrate the practice and advantages hereof. It is understood that the examples are given by way of illustration and are not intended to limit the specification or the claims to follow in any manner.

### Examples

Fluid Preparation

All samples of the fluids were multi-mixed with a Fann mixer for 60 minutes and rolled overnight at 150 degrees Fahrenheit before testing. Rheology was measured at 150° Fahrenheit. As shown in Table 1, the 70:30 OWR fluids produced emulsions with densities of 11.0 pounds per gallon using glycerine carbonate. The 90:10 OWR fluids produced fluids with densities of 12.0 pounds per gallon using glycerine carbonate or propylene carbonate.

| | Sample ID | | |
|---|---|---|---|
| | A2 | B2 | C2 |
| Density, | 11.0 | 12.0 | 12.0 |
| lb/gal | | | |
| Oil/Water | 70/30 | 90/10 | 90/10 |
| Ratio | | | |
| | Formula | Formula | Formula |
| Diesel #2, | 110 | 111.46 | 111.56 |
| lb | | | |
| Glycerine | 114.36 | 185 | 0 |
| Carbonate, lb | | | |
| Propylene | 0 | 0 | 170 |
| Carbonate, lb | | | |
| ADAPTA, | 2 | 2 | 2 |
| lb | | | |
| DRILTREAT, | 0 | 0.5 | 0.5 |
| lb | | | |
| LE | 8 | 8 | 8 |
| SUPERMUL, lb | | | |
| Rev Dust, | 20 | 20 | 20 |
| lb | | | |
| RHEMODL, | 2 | 2 | 2 |
| lb | | | |
| TAU MOD, | 0 | 4 | 4 |
| lb | | | |
| BAROID, | 85.26 | 131.8 | 147.2 |
| lb | | | |
| Water, lb | 110 | 29.3 | 28.93 |
| CaCl₂, lb | 40 | 10.17 | 10.05 |
| Lime, lb | 1 | 0 | 0 |
| Rolled, | 16 | 16 | 16 |
| hrs | | | |
| Rheology | 150 | 150 | 150 |
| Temp, F. | | | |
| 600 rpm | 153 | 170 | 285 |
| 300 rpm | 102 | 110 | 195 |
| 200 rpm | 74 | 64 | 161 |
| 100 rpm | 46 | 54 | 113 |
| 6 rpm | 10 | 8 | 44 |
| 3 rpm | 8 | 6 | 40 |
| Plastic | 51 | 60 | 90 |
| viscosity, cP | | | |
| Yield | 51 | 50 | 105 |
| point, lb/100 ft² | | | |
| 10 Sec | 9 | 6 | 54 |
| gel, lb/100 ft² | | | |
| 10 Min | 10 | 7 | 92 |
| gel, lb/100 ft² | | | |

ADAPTA™ is an HPHT filtration control agent, available from Halliburton Energy Services, Inc., Houston, Tex. DRILTREAT™ is an oil wetting agent, available from Halliburton Energy Services, Inc., Houston, Tex. LE SUPERMUL™ emulsifier is an invert emulsifier and oil-wetting agent, available from Halliburton Energy Services, Inc., Houston, Tex. REV DUST™ is an artificial drill solid available from Milwhite Inc., Houston Tex. RHEMOD L™ is a polymeric viscosifier, available from Halliburton Energy Services, Inc., Houston, Tex. TAU MOD™ is an amorphous/fibrous material as a viscosifier and suspension agent, available from Halliburton Energy Services, Inc., Houston, Tex. BAROID™ weighting material is a specially processed barite in powder, available from Halliburton Energy Services, Inc., Houston, Tex.

Generally, Yield Point (YP) is defined as the value obtained from the Bingham-Plastic rheological model when extrapolated to a shear rate of zero. It may be calculated using 300 rpm and 600 rpm shear rate readings as noted above on a standard oilfield rheometer, such as a FANN 35 or a FANN 75 rheometer. Plastic Viscosity (PV) is obtained from the Bingham-Plastic rheological model and represents the viscosity of a fluid when extrapolated to infinite shear rate. The PV is obtained from the 600 rpm and the 300 rpm readings as given below in Equation 1. A low PV may indicate that a fluid is capable of being used in rapid drilling because, among other things, the fluid has low viscosity upon exiting the drill bit and has an increased flow rate. A high PV may be caused by a viscous base fluid, excess colloidal solids, or both. The PV and YP are calculated by the following set of equations:

PV=(600 rpm reading)−(300 rpm reading) (Equation 1)

YP=(300 rpm reading)−PV (Equation 2)

As seen in the examples above, the fluids of the present invention containing at least one carbonate have improved rheological and separation properties.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Embodiments disclosed herein include:

A: A method of drilling in a subterranean formation comprising: drilling the subterranean formation with a drilling fluid, said drilling fluid comprising: a carbonate base fluid; and an aqueous base fluid.

B: A drilling fluid for drilling in a subterranean formation comprising: a carbonate base fluid; and an aqueous base fluid.

C: A method of drilling in a subterranean formation comprising: drilling the subterranean formation with a drilling fluid, said drilling fluid comprising glycerol carbonate.

D: A subterranean formation drilling system comprising: a drilling apparatus configured to drill with a drilling fluid, said drilling fluid comprising: a carbonate base fluid; an aqueous base fluid; and optionally, at least one base oil selected from the group of oils consisting of synthetic oils comprising an ester or olefin; diesel oils; mineral oils selected from the group consisting of n-paraffins, isoparaffins, cyclic alkanes, branched alkanes, polyethylene glycols, 1,3-propylene carbonate, dialkylcarbonates, dimethylcarbonate, and mixtures thereof.

E: A drilling fluid for drilling in a subterranean formation comprising glycerol carbonate.

Each of embodiments A, B, C, D and E may have one or more of the following additional elements in any combination: Element 1: wherein the carbonate base fluid comprises at least one of ethylene carbonate, propylene carbonate, glycerol carbonate, butylene carbonate, 1,3-propylene carbonate, dialkylcarbonates, dimethylcarbonate, and mixtures thereof. Element 2: wherein the carbonate base fluid comprises at least one of ethylene carbonate, glycerol carbonate, and mixtures thereof. Element 3: wherein the carbonate base fluid comprises glycerol carbonate. Element 4: wherein the aqueous base fluid comprises at least one of fresh water, acidified water, salt water, seawater, brine, an aqueous salt solution, glycols, alcohols, and mixtures thereof. Element 5: further comprising at least one base oil selected from the group of oils consisting of synthetic oils comprising an ester or olefin; diesel oils; mineral oils selected from the group consisting of n-paraffins, isoparaffins, cyclic alkanes, branched alkanes, polyethylene glycols, and mixtures thereof. Element 6: wherein the carbonate base fluid comprises glycerol carbonate and the base oil comprises diesel oil. Element 7: wherein the volume percentage oil base fluid with respect to the volume percentage of aqueous base fluid is about 50% to about 99%. Element 8: wherein the carbonate base fluid is present in the amount of about 1% to about 90% by volume. Element 9: wherein the drilling fluid includes at least one additive from the group consisting of weighting agents, inert solids, fluid loss control agents, emulsifiers, salts, dispersion aids, corrosion inhibitors, emulsion thinners, emulsion thickeners, viscosifiers, HPHT emulsifier filtration control agents, and any combination thereof. Element 10: wherein no aqueous base fluids are present. Element 11: wherein the drilling fluid is solids free.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A method of drilling in a subterranean formation comprising:
drilling the subterranean formation with a drilling fluid, said drilling fluid comprising:
a carbonate base fluid; and
an aqueous base fluid.

2. The method of claim 1, wherein the carbonate base fluid comprises at least one of ethylene carbonate, propylene carbonate, glycerol carbonate, butylene carbonate, 1,3-propylene carbonate, dialkylcarbonates, dimethylcarbonate, and mixtures thereof.

3. The method of claim 1, wherein the carbonate base fluid comprises at least one of ethylene carbonate, glycerol carbonate, and mixtures thereof.

4. The method of claim 1, wherein the carbonate base fluid comprises glycerol carbonate.

5. The method of claim 1, wherein the aqueous base fluid comprises at least one of fresh water, acidified water, salt water, seawater, brine, an aqueous salt solution, glycols, alcohols, and mixtures thereof.

6. The method of claim 1, further comprising at least one base oil selected from the group of oils consisting of synthetic oils comprising an ester or olefin; diesel oils; mineral oils selected from the group consisting of n-paraffins, isoparaffins, cyclic alkanes, branched alkanes, polyethylene glycols, and mixtures thereof.

7. The method of claim 6, wherein the carbonate base fluid comprises glycerol carbonate and the base oil comprises diesel oil.

8. The method of claim 6, wherein the volume percentage oil base fluid with respect to the volume percentage of aqueous base fluid is about 50% to about 99%.

9. The method of claim 1, wherein the carbonate base fluid is present in the amount of about 1% to about 90% by volume.

10. The method of claim 1, wherein the drilling fluid includes at least one additive from the group consisting of weighting agents, inert solids, fluid loss control agents, emulsifiers, salts, dispersion aids, corrosion inhibitors, emulsion thinners, emulsion thickeners, viscosifiers, HPHT emulsifier filtration control agents, and any combination thereof.

11. A drilling fluid for drilling in a subterranean formation comprising:
a carbonate base fluid; and
an aqueous base fluid.

12. The drilling fluid of claim 11, wherein the carbonate base fluid comprises at least one of ethylene carbonate, propylene carbonate, glycerol carbonate, butylene carbonate, 1,3-propylene carbonate, dialkylcarbonates, dimethylcarbonate, and mixtures thereof.

13. The drilling fluid of claim 11, wherein the aqueous base fluid comprises at least one of fresh water, acidified water, salt water, seawater, brine, an aqueous salt solution, glycols, alcohols, and mixtures thereof.

14. The drilling fluid of claim 11, further comprising at least one base oil selected from the group of oils consisting of synthetic oils comprising an ester or olefin; diesel oils; mineral oils selected from the group consisting of n-paraffins, isoparaffins, cyclic alkanes, branched alkanes, polyethylene glycols, and mixtures thereof.

15. The drilling fluid of claim 14, wherein the carbonate base fluid comprises glycerol carbonate and the base oil comprises diesel oil.

16. The drilling fluid of claim 11, wherein the volume percentage oil base fluid with respect to the volume percentage of aqueous base fluid is about 50% to about 100%.

17. The drilling fluid of claim 11, wherein the carbonate base fluid is present in the amount of about 1% to about 90% by volume.

18. The drilling fluid of claim 11, wherein the drilling fluid includes at least one additive from the group consisting of weighting agents, inert solids, fluid loss control agents, emulsifiers, salts, dispersion aids, corrosion inhibitors, emulsion thinners, emulsion thickeners, viscosifiers, HPHT emulsifier filtration control agents, and any combination thereof.

19. The drilling fluid of claim 11, wherein the drilling fluid is solids free.

20. A method of drilling in a subterranean formation comprising:
drilling the subterranean formation with a drilling fluid, said drilling fluid comprising glycerol carbonate.

21. The method of claim 20, further comprising at least one base oil selected from the group of oils consisting of synthetic oils comprising an ester or olefin; diesel oils; mineral oils selected from the group consisting of n-paraffins, isoparaffins, cyclic alkanes, branched alkanes, polyethylene glycols, and mixtures thereof.

22. The method of claim 20, wherein no aqueous base fluids are present.

23. A subterranean formation drilling system comprising:
a drilling apparatus configured to drill with a drilling fluid, said drilling fluid comprising:
a carbonate base fluid;
an aqueous base fluid; and
optionally, at least one base oil selected from the group of oils consisting of synthetic oils comprising an ester or olefin; diesel oils;
mineral oils selected from the group consisting of n-paraffins, isoparaffins, cyclic alkanes, branched alkanes, polyethylene glycols, 1,3-propylene carbonate, dialkylcarbonates, dimethylcarbonate, and mixtures thereof.
